(19) United States
(12) Patent Application Publication
(10) Pub. No.: US 2011/0018423 A1
(43) Pub. Date: Jan. 27, 2011

(54) INDIRECT HEATED CATHODE OF ION IMPLANTER

(76) Inventors: Terry SHENG, Saratoga, CA (US); Linnan CHEN, San Jose, CA (US); Jason HONG, San Jose, CA (US)

Correspondence Address: Muncy, Geissler, Olds & Lowe, PLLC, 4000 Legato Road, Suite 310, FAIRFAX, VA, 22033, US

(21) Appl. No.: 12/509,753

(22) Filed: Jul. 27, 2009

(51) Int. Cl. H01J 17/26; H01J 27/00

(52) U.S. Cl. 313/231.41; 250/426

(57) ABSTRACT

A proposed indirect heated cathode has an inner tubular shell inserted into an arc chamber for creating plasma by a filament, which is disposed in the inner tubular shell and then covered by an end cap. There are at least two outstanding talons disposed on the end surface of the inner tubular shell, and a step gap is configured on between the end surface of the inner tubular shell and the outstanding talons. The end cap can be lodged into the step gap, and fixed. Therefore, the end cap can be easily uncovered from the end of the inner tubular shell, as a result to simplify the replacement of the filament.

### FIELD OF THE INVENTION

The present invention relates to an indirect heated cathode of an ion implanter, and more particularly to an indirect heated cathode with outstanding talons configured at an end surface of an inner tubular shell of the cathode for lodging an end cap to cover a filament.

### BACKGROUND

Ion implantation has been used to dope impurity or ions into a wafer to fabricate a semiconductor wafer, and then the circuit can be manufactured on the semiconductor wafer to fabricate an integrated circuit chip. The concentration, depth and width of the impurity or ions on the semiconductor can be well controlled by the ion implanter.

An ion implanter, as shown as FIG. 1, mainly includes an ion source 100, an accelerator 20, a condenser 30, a magnetic field 40 and a support 50. The ion source 100 transfers the raw materials of the impurity into ions or clustered ions, and then the ions or clustered ions are extracted into the accelerator 20 to be accelerated to form an ion flow. The ion flow is condensed by the condenser 30 to form an ion beam and led by the magnetic field 40 to bombard onto a silicon wafer set on the support 50 to form a semiconductor wafer. For achieving a homogeneous distribution of the impurity or ions, one of two methods, namely rotating or scanning the wafer is generally used, where the scanning method is used in this example. Then the concentration, depth and the width are respectively determined by the ion source, the accelerator and the condenser.

The ion source 100 generally includes a source block and an arc chamber. The source block provides gaseous source and the arc chamber transforms the gaseous source into ions or clustered ions. The kind of the raw materials may be a solid matter, a condensed matter or a gaseous matter, and a vaporizer oven is usually utilized to vaporize the solid matter or the condensed matter. The gaseous source will be led into the arc chamber by an inlet or inlets.

The method used to transform the gaseous source into ions or clustered ions is to heat the filament, and then the electrons will be emitted from the heated filament. A cathode and an anode are configured in the arc chamber to accelerate the emitted electrons to strike the electrons out of the gaseous source, and then the gaseous source is transferred into ions or clustered ions to form plasma. Usually, a magnetic field is expressed over the arc chamber to spiral the flying path of the electrons for increasing the collision possibility, hence increases the ion density in plasma.

The filament tends to be degraded as being heated, so the filament should be replaced after a period for maintaining the efficiency. The cathode should be disposed near the filament. In general, there are two kinds of cathode, one is direct heated cathode and the other is indirect heated cathode. Indirect heated cathode is becoming the mainstream of the plasma source of the ion implantation for recent years, which uses filament to heat up cathode to emit thermic electrons to generate plasma in arc chamber. However, it becomes difficult to replace the filament. The present invention proposes a structure of the indirect heated cathode, which has an advantage of easy replacement of the filament.

### SUMMARY OF THE INVENTION

According to an aspect of the present invention, the cathode is inserted into an arc chamber through an opening of one side wall. The portion of the cathode inside the arc chamber is surrounded by an outer tubular shell and an inner tubular shell. The end of the outer tubular shell is disposed with a salient toroid. At least two talons are distributed on the end surface of the inner tubular shell of the cathode. A step gap is configured on between the end surface of the inner tubular shell and the talons, so an end cap can be lodged into the step gap for covering the filament. The inner tubular shell extends out of the arc chamber, and is clamped by a slab. At least one fillister is designed on the outer surface of the extended portion, and corresponding to the position of the slab to reduce the heat loss from the end cap. The legs of the filament penetrate through an insulating plate to connect with the current source.

### BRIEF DESCRIPTION OF THE DRAWINGS

FIG. 1 is a schematic view of an ion implanter.

FIG. 2 is an exploded view illustrating relative positions between components of the arc chamber and the cathode.

FIG. 3 is a schematic exploded view illustrating combination of the cathode and the first end wall of the arc chamber.

FIG. 4 is a schematic exploded view illustrating decomposition of the cathode and the first end wall as illustrated in FIG. 4.

FIG. 5A is an exploded view illustrating relative positions of the filament, the end cap and the inner tubular shell.

FIG. 5B is a sectional view illustrating combination of the filament, the end cap and the inner tubular shell.

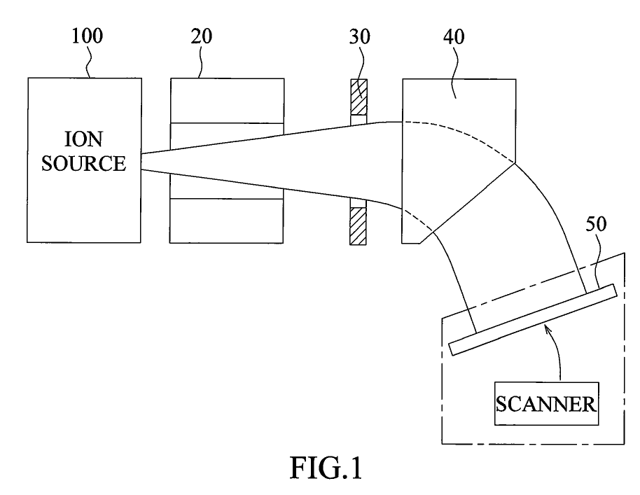

### DESCRIPTION OF THE EXEMPLARY EMBODIMENTS

As described in the background, the indirect heated cathode is inserted into the arc chamber for creating plasma, which is to transform the gaseous source into ions or clustered ions. In one example, the indirect heated cathode is inserted into an opening of the end wall of the arc chamber to create plasma as the current is conducted to heat the filament in the cathode. The plasma can be led to an aperture of the chamber and extracted into the accelerator to form an ion flow, and then the ion flow is focused by the condenser to form an ion beam. The ion beam can be used to dope the impurity of the wafer. The condenser, in general, is formed by a plurality of magnetic fields, and those magnetic fields push the ions to the center of the tube of the channel of the ion implanter, so that is also called lens of charged particle beam. For better understanding, some exemplary embodiments accompanying with figures are employed to explain the scope of the invention.

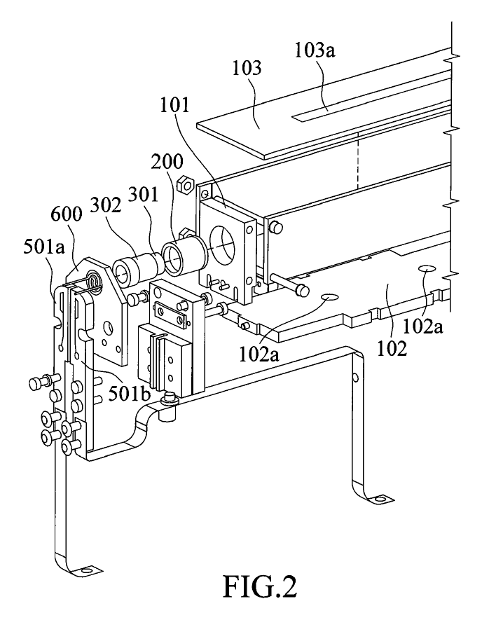

The relative positions of the components of the arc chamber and the cathode are illustrated in FIG. 2, wherein a portion of the arc chamber is illustrated in the right half and the cathode in left half with an exploded view. The arc chamber is confined by six walls, a first end wall 101, a second end wall, a bottom wall 102, a top wall 103, a first side wall and a second side wall. At least one inlet 102a is disposed on the bottom wall 102 for leading the gaseous source from the source block into the arc chamber, such as two through holes in this example, where the inlet number depends on machines. An aperture 103a is disposed through the top wall 103 to inject the plasma into the accelerator for forming an ion beam. Usually, a magnetic field is employed to enhance plasma generation efficiency. A vaporizer oven is equipped to vaporize solid raw material of the impurity into the gaseous source if the raw material is solid or condensed.

A cathode and an electron repeller are respectively disposed near the first end wall and the second end wall to transform the gaseous source into plasma. Electrical current is conducted in a filament to generate heat and the heated filament emits thermic electrons. The emitted electrons are pulled out and accelerated by an electrical field and bombard on cathode when a voltage is applied between the cathode and filament. Cathode is heated by electron bombardments and emits thermic electrons into arc chamber. Emitted thermic electrons are accelerated through arc voltage established between cathode and arc chamber, which serves as anode in arc discharge. The accelerated electrons collides with the atoms or clustered atoms of the gaseous source to strike the electrons out of the atoms or the clustered atoms to form the plasma. In general, a magnetic field is used to spiral the flying path of the electrons in arc chamber to form a helix path to increase the collision possibility of electrons and the atoms or clustered atoms of the gaseous source for enhancing the efficiency of ionization process.

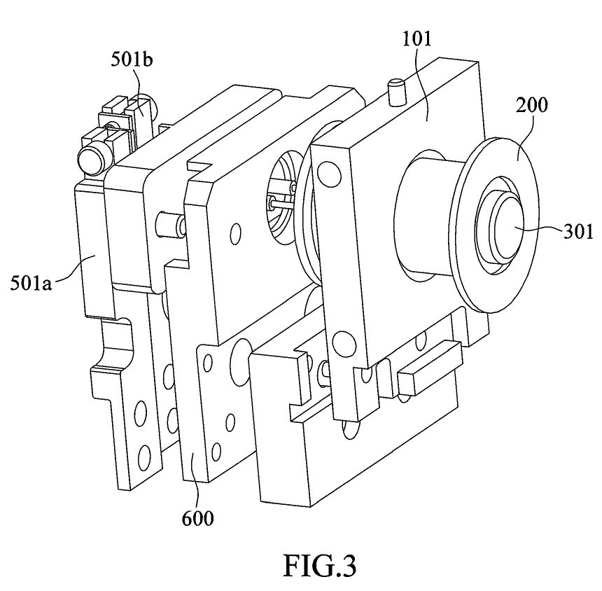

Referring to FIG. 3, the cathode is spaced apart from the first end wall 101 when the cathode is inserted into the opening of the first wall 101. An outer tubular shell 200 is disposed in-between the inner tubular shell with an end cap 301 and the opening of the first end wall 101 to avoid the arc discharge spreading out of arc chamber through the gap between the outer tubular shell 200 and the first end wall 101 or the electrical short caused by peeling/flaking inside arc chamber, as illustrated in FIG. 3. Further, a salient toroid is configured at the end of the outer tubular shell 200, and the salient toroid has a larger diameter than the opening of the first end wall to effectively reduce the deposition over outside of arc chamber.

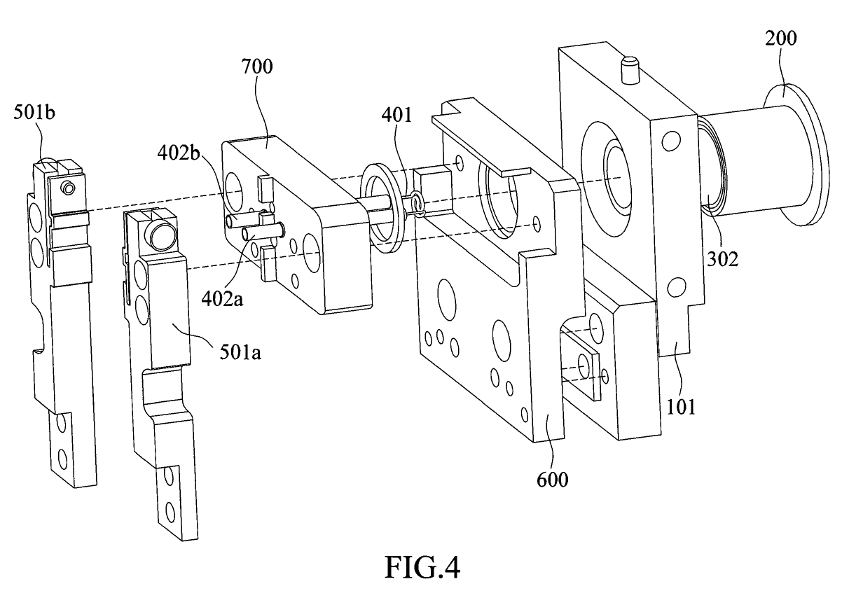

Referring to FIG. 4, the inner tubular shell of the cathode extends out of the arc chamber and is clamped by slab 600, which is closely mounted onto the first end wall 101 of the arc chamber through a dielectric piece. An opening configured through the slab 600 to clamp and support the inner tubular shell 302 of the cathode, so the opening of the slab 600 and the opening of the first end wall 101 are aligned. The two legs 402a, 402b extending from the filament are through an insulating plate 700, and two arms 501a, 501b are used to respectively clamp and connect the two legs 402a, 402b of the filament with a current source for heating the filament.

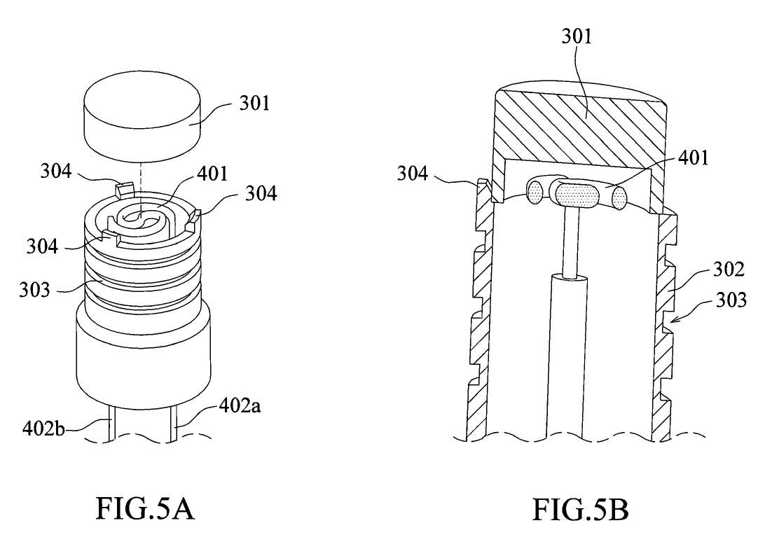

As illustrating in FIGS. 5A and 5B, the cathode mainly comprises the filament 401, the inner tubular shell 302 and the end cap 301. The filament 401 degrades with usage, so the filament 401 should be replaced in a period of use for maintaining its efficiency. At least two outstanding talons 304 are configured at the end portion of the inner tubular shell 302, and the end cap 301 can be lodged into the outstanding talons 304 to cover the filament 401. Even though three talons 304 are illustrated in FIG. 5A as an example, however the number of the outstanding talons 304 is not limited thereto. It is emphatically noted the outstanding talons 304 are distributed on the end surface of the inner tubular shell 302, and a step gap is configured on between the outstanding talons 304 and the end surface of the inner tubular shell 302. For example, a virtual ring encircling the outstanding talons 304 has the same outer diameter as but larger inner diameter than that of the inner tubular shell. Therefore, the end cap 301 can be lodged into the step gap to cover the filament 401.

Accordingly, the outstanding talons 304 formed at the end surface of the inner tubular shell would facilitate easy replacement of the filament 401. It is emphatically noted that the width of the step gap is not limited, which depends on the requirement of the ion implanter.

FIG. 5B illustrates the combination of the end cap 301 and the inner tubular shell 302 from a sectional view. The outer surface of the extension portion of the inner tubular shell is equipped with at least one fillister 303 to reduce thermal conductivity of the inner tubular shell to reduce heat loss from end cap 301.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An indirect heated cathode, configured in an arc chamber, wherein said arc chamber transforms a gaseous source into plasma and said arc chamber has a first end wall, a second end wall, a bottom wall, a top wall, a first side wall and a second side wall and at least one inlet through said bottom wall, comprising:
an outer tubular shell projected into said arc chamber through an opening of said first end wall;
an inner tubular shell inserted into and spaced apart from said outer tubular shell, wherein said inner tubular shell comprises at least two outstanding talons distributed on an end surface of said inner tubular shell, and a step gap is configured on between said end surface of said inner tubular shell and said outstanding talons;
a filament in said inner tubular shell; and
an end cap lodged into said step gap to cover said filament.

2. An indirect heated cathode according to claim 1, wherein a number of said outstanding talons is three.

3. An indirect heated cathode according to claim 1, wherein said outer tubular shell of said cathode has a salient toroid with a larger diameter than said opening of said first end wall for reducing deposition over outside of said arc chamber.

4. An indirect heated cathode according to claim 1, wherein an outer surface of an extension portion of said inner tubular shell comprises at least one fillister to reduce heat loss from said end cap.
